(19) United States
(12) Patent Application Publication
(10) Pub. No.: US 2015/0317169 A1
(43) Pub. Date: Nov. 5, 2015

(54) CONSTRUCTING AND OPERATING HIGH-PERFORMANCE UNIFIED COMPUTE INFRASTRUCTURE ACROSS GEO-DISTRIBUTED DATACENTERS

(71) Applicant: Midfin Systems Inc., Redmond, WA (US)

(72) Inventors: Suyash Sinha, Kirkland, WA (US); Shuvabrata Ganguly, Kirkland, WA (US); Ajith Jayamohan, Redmond, WA (US)

(21) Appl. No.: 14/702,589

(22) Filed: May 1, 2015

Related U.S. Application Data
(60) Provisional application No. 61/988,218, filed on May 4, 2014.

(51) Int. Cl. G06F 9/44; H04L 29/12

(52) U.S. Cl. CPC G06F 9/4416; H04L 61/2076

(57) ABSTRACT

Systems and methods are disclosed for provisioning and managing cloud-computing resources, such as in datacenters. One or more network controllers enable the creation of a unified compute infrastructure and a private cloud from connected resources such as physical and virtual servers. Such controller instances can be virtual or physical, such as a top-of-rack switch, and collectively form a distributed control plane.

### CROSS-REFERENCE TO RELATED APPLICATION(S)

This application claims the benefit of U.S. Provisional Application No. 61/988,218, filed May 4, 2014, titled “Automatic Private Cloud Provisioning & Management Using One or More Appliances and a Distributed Control Plane,” which is incorporated herein by reference in its entirety.

### TECHNICAL FIELD

The present disclosure relates to the deployment and management of cloud computing resources.

### BACKGROUND

There are numerous large public cloud providers like Amazon Web Services®, Microsoft® Azure™, etc. They have hundreds, or thousands, of software engineers and researchers who create proprietary software to provision commodity servers into cloud-computing resources like virtualized compute, storage and network capabilities. Such public cloud providers have huge datacenters where such proprietary software executes. It takes years to create an infrastructure and software services to be able to create a cloud of this scale.

There are some open source software like OpenStack®, CloudStack® and Eucalyptus® that are also used to “provision” cloud resources, e.g., install the software on commodity servers inside organizations (such as enterprise, small and medium businesses, etc.). It can take months to deploy such software in an enterprise setting having many computers and can require expert consultants.

Some software vendors, e.g., VMWare® and Microsoft®, have software solutions that require experts to configure, provision and deploy. The solution then can start to provision servers into a private cloud. This also can take months to deploy.

### BRIEF DESCRIPTION OF THE DRAWINGS

FIG. 1 is a high-level schematic diagram illustrating a logical relationship between a Software Defined Fabric Controller (“SDFC”) and individual SDFC instances in accordance with an embodiment of the technology.

FIG. 2 is a block diagram illustrating some components of an SDFC controller configured in accordance with an embodiment of the technology.

FIG. 3 is a high-level data flow diagram illustrating data flow in an arrangement of some components of an SDFC controller configured in accordance with an embodiment of the technology.

FIG. 4 is a schematic diagram illustrating an arrangement of components in a bump-in-the-wire mode accordance with an embodiment of the technology.

FIG. 5 is a schematic diagram illustrating an arrangement of components forming a virtual Clos network in accordance with an embodiment of the technology.

FIG. 6 is a block diagram illustrating separate software containers on an SDFC controller in accordance with an embodiment of the technology.

FIG. 7 is a flow diagram illustrating steps to provision a server in an SDFC in accordance with an embodiment of the technology.

FIG. 8 is a data flow diagram illustrating SDFC VLAN Translation in Fabric mode in accordance with an embodiment of the technology.

FIG. 9 is a data flow diagram illustrating SDFC VLAN Translation in Virtual Wire mode in accordance with an embodiment of the technology.

FIG. 10 is a sequence diagram illustrating virtualized network function interactions in accordance with an embodiment of the technology.

### DETAILED DESCRIPTION

### Overview

In some embodiments of the present disclosure, a computer-based controller, whether physical or virtual, in a rack of servers is used to provision and manage cloud-computing resources, using the servers in the rack connected to the controller by physical or virtual links. Provisioning is understood in the art to mean install and configure a device, e.g., with operating system, networking, application, and/or other software. One or more of such controllers are connected to a computer-based distributed control plane that acts as an orchestrator across the connected controllers. The controller can provision virtual machines, virtual networks, and virtual storage on the multiple servers connected to it, with or without the use of agent software that it can statically or dynamically inject into a server's or virtual machine's operating system and/or application stack.

In some embodiments of the present disclosure, the computer-based controller can also act as a switching and/or routing device in the network, such as a top of rack (“ToR”) switch. In some embodiments of the present disclosure, the computer-based controller can obviate the need for another rack-level switch and/or router. In some embodiments, it can coexist with another rack-level switch and/or router. In various embodiments, the controller can create a private cloud using the servers in the rack.

The present disclosure describes technology including systems and methods for making the deployment of on-premises cloud-computing resources (e.g., compute, storage and network resources) easier, more agile and less costly for administrators of datacenters. In various embodiments, the technology disclosed herein includes one or more physical or virtual controllers, along with associated software components running in the cloud and in host servers, that in combination can automatically provision a private cloud in a datacenter environment, and provide the ability to manage and monitor it remotely by end-users using a web-based dashboard. Other embodiments of the presently disclosed technology may differ in one or more of the components involved in its end to end design.

### Software-Defined Fabric Controller (“SDFC”)

The technology of the present disclosure includes, in various embodiments, a new class of distributed infrastructure technology called a Software-Defined Fabric Controller (“SDFC”). An SDFC can be, for example, a physical or virtual datacenter “orchestrator” controller, e.g., that can “orchestrate” other hardware and/or software. Orchestration can include configuring, managing, and/or controlling the other hardware and/or software. An SDFC can automatically construct and operate high-performance datacenter infrastructure at scale. It can provide these performance and scale benefits across one or more datacenters over commodity physical servers. These capabilities of “stitching together” disparate compute systems across networks (e.g., the Internet) can affect how datacenters are designed and implemented.

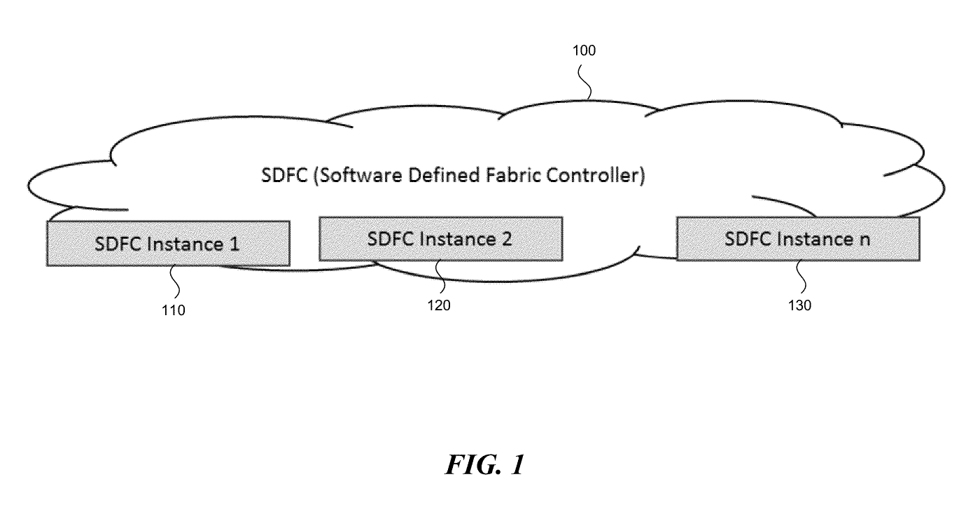

FIG. 1 is a high-level schematic diagram illustrating the logical relationship between a Software Defined Fabric Controller (“SDFC”) 100 and individual “SDFC instances” 110-130 in accordance with an embodiment of the technology. In various embodiments of the technology, an SDFC 100 is a distributed or collective entity in which its intelligence is distributed across multiple SDFC instances 110-130 (e.g., controllers) that collectively form the SDFC 100. In some embodiments, a distributed control plane of the SDFC includes software that executes on multiple SDFC instances or other computer servers. As a result, such an SDFC does not have a single point of failure. For example, if the SDFC Instance 1 110 fails, it can be replaced with a new SDFC instance without needing to first configure such a replacement instance. The new instance automatically inherits the state of the SDFC Instance 1 110 once it starts operating as part of the overall SDFC 100. When an instance within the overall SDFC 100 malfunctions, it can be individually replaced without affecting the collective state. Furthermore, when a new SDFC instance is provisioned, it automatically inherits the state that its predecessor required from the collective SDFC 100. In some embodiments, an SDFC 100 distributes its intelligence (e.g., software state), recognizes new instances, and communicates state according to a multi-way communication protocol. An example of such a protocol is further described below.

In some embodiments, the collective distributed state of an SDFC is contained in a namespace (e.g., an SDFC Namespace (“SN”)). Such an SN can be associated with a particular datacenter governing entity; for example, a company or a customer account. In some embodiments, one SDFC is associated with exactly one SN. An SDFC and its SN may have multiple (e.g., thousands of) instances, each instance controlling exactly one virtual chassis of connected servers, as described below. The SN maintains visibility across all instances contained in it, and exposes SDFC APIs that can be called to manipulate the operation of individual instances inside the SN and/or modify the SN state. For example, SDFC APIs can include resource tagging (e.g., to create, update, modify, and/or delete tuples tagging various objects) and targeting based on resource tagging (e.g., an operation on an SN instance matching tag). In some embodiments, the SDFC APIs are modeled after a REST (Representational State Transfer) architectural style. In such an SN, operations on each state object can be expressed through, e.g., the “create, read, update, delete” (“CRUD”) semantics of REST. More information on REST can be found at a Wikipedia web page entitled “Representational State Transfer, which web page is hereby incorporated by reference in its entirety. In various embodiments of the technology, all control, configuration and operation state belongs to the SN and is synchronized across all instances contained in it. In some embodiments, the SDFC uses a communication algorithm that exchanges or otherwise distributes SN state information and that handles intermittent network failures.

State information that can belong to the SN includes, for example, control state, configuration state, and operation state. As an example, control state can include the status of a set of commands across multiple SDFC instances in various stages such as pending, completed, timed out, etc. Configuration state can include, for example, a set of “blueprint” templates of virtual servers that indicate resource container requirements of one or more virtual resources such as virtual networks, virtual disks, and/or virtual servers; virtual machine (“VM”) resource requirements such as numbers and/or amounts of VCPUs, Memory, Disks and Virtual Networks; and/or allocation of provisioned resources, such as bandwidth for disks and/or network interfaces (e.g., 1000 input/output operations per second (“IOPS”) on a virtual disk). Operational State, for another example, can include conditions of each of a set of controllers in various states such as active, degraded, or offline; states of each of a set of physical servers connected to controllers, such as offline, online, provisioned, discovered, etc.; VM states of a set of virtual servers connected to controllers, such as created, started, running, terminated, stopped, paused, etc.; disks connected to physical or virtual servers; networks; et al.

### SDFC Instance

SDFC instances are logical entities comprising operating logic (e.g., “eFabric” or “eFabric OS” software, firmware, or circuitry) and local state. In various embodiments of an SDFC, an SDFC instance is connected to other instances over a network and shares its local state with N of its reachable neighboring instances. In some embodiments, a value of N>=2 enables the SDFC to handle individual instance failures.

Individual instances of an SDFC can be instantiated as physical or virtual controllers. For example, in the physical controller model, an instance can be connected through a physical network cable to the physical servers in at least three ways. First, an instance can be connected as a bump-in-the-wire (“BITW”) between physical servers and an existing Top-of-the-Rack (“TOR” or “ToR”) switch within the datacenter rack, where it is practically invisible to the upstream and downstream network endpoints (e.g., routers or servers). In a BITW configuration, an SDFC intercepts data in transit, processes it, and retransmits it transparently to the other devices on the network. Second, an instance can be connected and configured as a ToR switch, where it operates as such a switch for all compute or storage servers connected to it in the physical rack using broadly available switching and routing software in combination with the SDFC eFabric software. Third, an instance can be connected as an edge device, directly connected to the Internet on its uplinks and to servers on its downlinks.

As another example, in the virtual controller model, an instance can run as a software service implemented as one or more virtual machines that are logically connected to the servers through virtual network connections. For example, an SDFC instance can include eFabric software running inside a virtualized environment such as a virtual server or a virtual switch.

In some embodiments, an SDFC instance such as a physical controller is configured such that some or all of the physical resources of the servers directly attached to the controller form an elastic pool of virtualized resources. The set of hardware comprising a given controller and the servers directly attached to it can thus form one logical pool of, e.g., compute, memory, storage, and/or network resources that are together also referred to as a “virtual chassis”. In some embodiments, each SDFC instance (physical or virtual) creates a virtual chassis comprising all servers connected to it. In some embodiments, each virtual chassis has one SDFC physical or virtual controller and one or more servers associated with it. In some embodiments, each SDFC instance controls exactly one virtual chassis. Many such virtual chassis can exist in a single datacenter or across multiple datacenters. When all servers within a virtual chassis share a certain desired level of network proximity in terms of latency, such a virtual chassis can also be referred to as a “proximity zone”.

In some embodiments, the pool of resources within a virtual chassis are exposed through the global SDFC namespace and can be configured and modified by changing the global SDFC state through the SDFC API. For example, virtual machines can be created on a virtual chassis using the SDFC API.

### Physical Controller

In some embodiments, an SDFC instance can be implemented in a physical controller device (“controller”), such that many such controllers together form the SDFC. Such an SDFC instance can include a network application-specific integrated circuit (“ASIC”) to control networking hardware such as a switch appliance; one or more central processing units (“CPUs”) for executing computer programs; a computer memory for storing programs and data—including data structures, database tables, other data tables, etc.—while they are being used; a persistent storage device, such as a hard drive, for persistently storing programs and data; a computer-readable media drive, such as a USB flash drive, for reading programs and data stored on a computer-readable medium; and a network connection for connecting the computer system to other computer systems to exchange programs and/or data—including data structures—such as via the Internet or another network and its networking hardware, such as switches, routers, repeaters, electrical cables and optical fibers, light emitters and receivers, radio transmitters and receivers, and the like. The terms “memory” and “computer-readable storage medium” include any combination of temporary and/or permanent storage, e.g., read-only memory (ROM) and writable memory (e.g., random access memory or RAM), writable non-volatile memory such as flash memory, hard drives, removable media, magnetically or optically readable discs, nanotechnology memory, synthetic biological memory, and so forth, but do not include a propagating signal per se. In various embodiments, the facility can be accessed by any suitable user interface including Web services calls to suitable APIs. For example, in some embodiments, an SDFC instance includes eFabric software running on a hardware controller including one or more central processing units (e.g., x86, x64, ARM®, PowerPC®, and/or other microprocessor architectures), memory, non-volatile storage (flash, SSD, hard disk, etc.), and an off-the-shelf switching silicon (Broadcom®, Inter/Fulcrum, Marvell®, etc.). The controller can be attached to physical servers using standard Ethernet cables (copper, optical, etc.) of varying throughput (1 Gbps, 10 Gbps, 25 Gbps, 40 Gbps, 100 Gbps, and so on), depending of the specific model of the controller, on its network ports configured as downlink ports. While computer systems configured as described above are typically used to support the operation of the technology, one of ordinary skill in the art will appreciate that the technology may be implemented using devices of various types and configurations, and having various components.

In some embodiments of the present disclosure, the controller is a physical network device. For example, such a controller can take the physical form factor of a 48-port 1-U 1 GigE or 10 GigE device. In such an embodiment, the Controller can act in modes of network operation including, for instance: Smart ToR mode (or Fabric mode), Virtual Wire mode, and/or Edge mode.

In the Smart ToR mode, the controller is configured as a drop-in replacement for a top-of-the-rack switch to which all physical servers in the rack are connected. In some embodiments of this mode, 42 ports on a 48-port controller are available to connect to physical servers, with 4 ports used as upstream ports for connectivity to aggregation layer switches for northbound traffic (e.g., for redundancy, one pair connected to one upstream router and another pair to a different router). In some embodiments, each SDFC instance has one or more management ports connected to a customer network with Internet access. In some embodiments, one pair of ports (e.g., the 24th and 48th port) is used as redundant management ports for connectivity to the distributed SDFC control plane. The SDFC instance reaches the distributed control plane via, e.g., an SSL/HTTPS endpoint (“Switchboard”).

In this hardware configuration, the controller constructs a virtual network bridge between the uplink and downlink ports, creating virtual ports or links that the controller can intercept. The controller also supports multiple physical servers connected to a single downstream port through, for example, the use of an intermediate, dumb level 2 switch to support blade server configurations aggregated in one physical port. The controller provides a bridge internally to switch network packets from one port to another and delivers egress traffic to the uplink ports. In some embodiments, the controller constructs a single virtual network bridge that connects all the downstream ports and provides the same capabilities for interception of selected traffic. The controller can trap or intercept, for example, specified protocol messages (e.g., OSI layer 3 or 4) such as DHCP Request and DHCP Response options, and/or traffic that matches based on 5-tuple entries provided in a network Access Control List (“ACL”) for the implementation of a Firewall rule.

In the Virtual Wire mode, ports are configured as uplink and downlink ports. Each uplink and downlink port pair is virtually connected as a two-port switch. Traffic between servers and the ToR switch passes through the controller. In the virtual wire configuration, there is no cross-talk across the ports. For example, traffic may exit the northbound port of the controller to the next layer of the network (e.g., the ToR) and then return back to the controller's north ports to be directed to another server internal to the virtual chassis.

Both in ToR/Fabric and Virtual Wire configurations, controllers can be configured to be in an active-active failover state, deploying a redundant controller operating in the same mode as the primary. For example, in an active-active failover hardware configuration with a pair of controllers, there are two network connections from a single physical server: one attached to Controller A and another to Controller B. In this configuration, both controllers use the same shared state and manage the connected servers in unison. If one controller is network partitioned or fails due to hardware or software issues, the other controller can take over SDFC operations without any change in state of servers or virtual machines running in the substrate. In various embodiments, the technology supports other failover modes, such as active/passive and/or N+M.

In the Edge mode, the controller acts as a single network gateway controlling, for example, DNS, DHCP, and edge network WAN services directly for the connected unified compute rack. All ports on the fabric controller can be automatically configured to detect server hardware and any management port (e.g., IPMI) access for the associated server. In some embodiments, two ports (e.g., port 24 and port 48) are used as an edge gateway to connect to an ISP network for direct connectivity. The controller also performs private and public network address translation (“NAT”) mappings in Edge mode to enable servers and virtual machines to control their public and private IP mappings as part of the initialization. In some embodiments, the controller operates in a fully remote-access management mode. For example, in the Edge model, an SDFC instance and its virtual chassis can operate in isolation in a co-location or content delivery network exchange with only one pair of Internet-connected wires reaching it.

### Components Implementable in Software

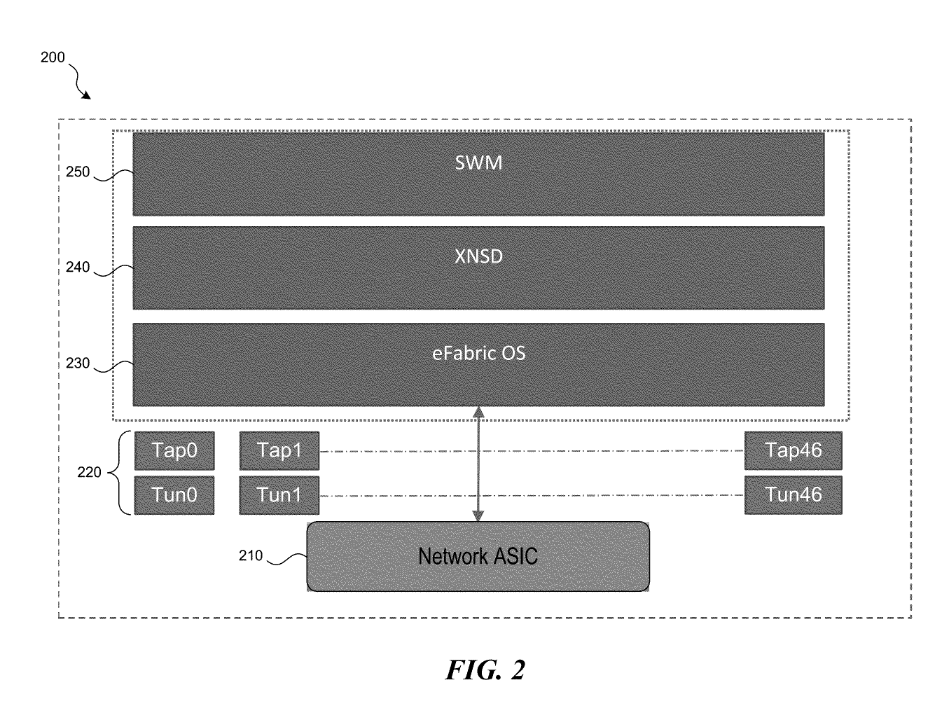

FIG. 2 is a block diagram illustrating some of the components of an SDFC controller 200 configured in accordance with an embodiment of the disclosure. In various embodiments, the components can be implemented as software, firmware, hardware, or some combination of these and other forms. A network ASIC 210 controls the switching of data among ports 220. The ports 220 can be physical uplink and downlink ports and/or virtual ports (e.g., a virtual TAP/TUN device emulating network connections). The illustrated ports 220 include 47 pairs of Tap (network tap) and Tun (network tunnel) ports (0-46), e.g., relating to a 48-port switch. The eFabric OS software 230 commands and configures the network ASIC 210, such as further described below. For example, the eFabric OS enables configurable hardware acceleration of switching arrangements.

An extensible network switch component or daemon (“XNS” or “XNSD”) 240 is a software-defined network service responsible for network virtualization, discovery, and network deep-packet inspection. The XNSD 240 can provide, for example, network function offload capabilities for the fabric controller, as further described below. Such offloading enables the eFabric software to configure the ASIC to perform hardware acceleration on virtual network functions, for example. In some embodiments, the XNSD is configured to be interoperable with different merchant silicon through, e.g., a switch ASIC abstraction layer (“SAI”) that allows XNS to program the network ASIC for network functions such as source or destination MAC learning, dynamic VLAN construction, Packet interception based on 5-tuple match, and more. A switch manager (“SWM”) component 250 is responsible for provisioning, command and control and event coordination, management and monitoring of server infrastructure connected to the controller. Via such components, the technology can provide API interfaces to enable distributed programming of network functions across one, multiple, or all SDFC controllers from the distributed control plane.

In various embodiments, the technology includes software controlling the operation of the physical and/or virtual SDFC controllers. For example, individual instances of SDFC can include a lean firmware-like operating system such as the eFabric OS. In some embodiments, the eFabric OS runs on all SDFC controllers and servers managed by the SDFC. eFabric is capable of running inside physical or virtual machine environments.

In various embodiments, eFabric provides functionality supporting the operation of the overall SDFC including discovery of other reachable SDFC instances; mutual authentication of SDFC instances; messaging primitives for SDFC communication across instances; a local state repository to persist the portion of SDFC namespace state that is locally relevant; and a communication protocol for state synchronization, such as the Multi-Way Gossip Protocol (“MwGP”) further described below.

In various embodiments of the technology, multiple SDFC instances (e.g., ToR controllers) form a distributed control plane, and can also be controlled and orchestrated by a cloud-based control plane. In some embodiments, each SDFC controller has a discovery mode to detect the control plane, such as through a well-known discovery service endpoint that provides information about the Internet endpoint available specific to one or more groups of SDFC controllers. Once the controllers are powered on, they reach out to the discovery service endpoint and then register with the control plane endpoint running elsewhere in the network. This control plane endpoint can be on-premises or off-premises from the network perspective of the SDFC controller.

An SDFC controller can establish a secure connection (e.g., via SSL or TLS) to the Switchboard control plane endpoint. Switchboard serves as a front-end authentication and communication dispatch system. In some embodiments, as each SDFC controller connects to Switchboard, a controller-unique pre-shared key is used to verify authentication, which is then rotated to new keys for additional security. SDFC can, for example, publish state information about the controllers, the servers attached to the controllers, and the virtual machines running in those servers through the MwGP protocol described below. The SDFC maintains all relevant state under its purview in a local database and performs incremental state updates to the Switchboard endpoint to update the cloud-based control plane. If the information in the control plane is lost, for example, the SDFC can provide a full sync and restore this information back in the control plane. If the SDFC loses its local information (for e.g., controller replacement due to hardware failure), the control plane can perform a full sync and restore the full state as well.

In some embodiments, in terms of orchestration, the SDFC can use a work-stealing model of handling requests from the customer (e.g., made through a dashboard interface or API endpoints). In today's public-cloud environments, this is typically done through a service with a front-end load balancer acting as the arbiter and decision-maker on where a specific request should go, i.e., which physical server will receive the request. This model of placement can form a choke point in current control plane designs, leading to brown-outs in such a control plane and outages in cloud environments. The work-stealing model instead distributes the orchestration across all the SDFC controllers involved, and as a result there is no longer a single arbiter service deciding the placement for an availability zone. For example, if one proximity zone (a rack-level boundary for interacting with the control plane containing one SDFC instance) fails, others can pick up the request from the control plane through the work-stealing model. This approach provides high resiliency due to its distributed nature and improves the availability of the overall system.

In some embodiments of an SDFC instance, eFabric software runs inside a physical controller that resembles a Top of Rack (ToR) switch. For illustrative purposes, functionality of eFabric software is described herein in reference to such an embodiment.

In some embodiments, the eFabric enables each SDFC instance (e.g., each instance running in a ToR controller) to generally discover who its reachable neighbors are, and to specifically discover what other SDFC instances are its reachable neighbors. For example, eFabric can discover such neighbors through a directory service and/or through direct network connectivity. Once it detects its neighbors, it begins communication (e.g., via the Multi-Way Gossip Protocol with multiple paired participants at the same time) wherein it exchanges state fragments with its selected neighbors. For example, it can use a pair-wise transaction counter that is incremented every time the state fragments are exchanged. At any time, state fragments that are most relevant to a proximity zone automatically percolate to that proximity zone.

When an SDFC instance goes down, or is unreachable, it continues to attempt to keep track of all asynchronous state changes that happen within its own proximity zone. It also keeps attempting to reach its neighbors in other proximity zones. Whenever the normal operation of the network is restored, the diverged state fragments are automatically merged, leading to eventual state convergence (“snap and converge”).

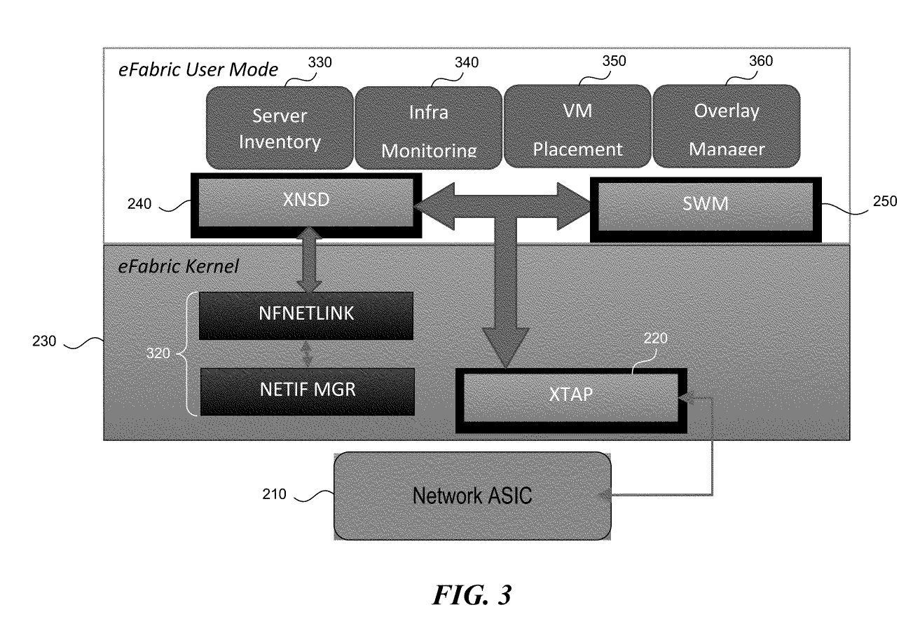

FIG. 3 is a high-level data flow diagram illustrating data flow in an arrangement of some components of an SDFC controller configured in accordance with an embodiment of the technology. During the initialization of the controller, the XNSD 240 starts up and runs as a service in the background listening for network events (as selected by policies for various use cases) reported by the eFabric OS 230 after installing its initial handlers. The XNSD 240 then enumerates all ports in the controller and creates a virtual port map of the physical ports which are then managed through the Linux kernel NETLINK interface 320 as part of the eFabric OS. NETLINK 320 is used as the conduit to transfer network port and state information from the eFabric kernel 230 to the XNSD process 240. As the system learns about the network through interception of the NETLINK 320 family of messages like NETLINK_ROUTE, NETLINK_FIREWALL and the like, XNSD 240 constructs the network state of the port and pushes the information back to the ASIC 210 for hardware accelerated routing and switching of packets. In some embodiments, an extensible virtual network TAP device (“XTAP”) 220, an OSI layer 2 device, works in coordination with the XNSD 240 to create software-defined bridging and network overlap topologies within the fabric controller that forms the software defined network.

The XNSD 240 supports interception of packets using one or more packet fields. Example packet fields are source and destination MAC addresses, IP addresses, etc. Packet interception is enabled by programming entries in the Switching ASIC 210 such that any packet that matches the filter is redirected to the CPU of the controller. For example, a provisioning application may install a handler to intercept dynamic host control protocol (“DHCP”) traffic to install preboot execution environment (“PXE”) boot images as servers are powered on. The pattern in that case is specified by the provisioning application. As another example, a firewall may request intercept handlers for source and destination IP addresses, port numbers, and protocols based on access control list (“ACL”) rules requested by a user via firewall settings. Since ASIC tables are limited in size, the XNSD 240 performs smart aggregation of intercepts in case of overlaps. For example if multiple applications register overlapping intercepts, XNSD installs only one entry in the switching ASIC 210, deferring further classification to software. As a result, the number of entries required in the ASIC 210 is reduced.

In some embodiments, the XNSD 240 exposes a priority queue-based interface for isolating network applications from each other as they need to access hardware features. When applications desire to configure state of the underlying switching ASIC 210, the commands are submitted through an application-specific queue to the XNSD 240. The XNSD 240 then resolves the competing configurations of the applications based on, e.g., their relative priorities and the underlying set of invariant states that it must maintain to keep the switching ASIC 210 in a functioning state.

The queue-based priority mechanism can also be used to throttle data-plane traffic that does not pass through the controller, i.e., data destined for an application running on the CPU connected to the switching ASIC 210. For example, such applications can include a server inventory application 330, an infrastructure monitoring application 340, a virtual machine placement application 350, an overlay manager application 360, etc.

In some embodiments, a switch manager (“SWM”) 250 includes a set of applications running on an SDFC controller. SWM 250 applications are responsible for various tasks such as automatic server discovery, server provisioning, VM lifetime management, performance monitoring, and health monitoring. SWM 250 applications maintain their own state in a local database and synchronize state with the distributed control plane using MwGP. Such state includes state of servers (IP address, MAC address, etc.), state of VMs, etc.

In some embodiments, the SWM 250 is responsible for managing physical and virtual infrastructure assets and acts as a runtime for other applications running in the fabric controller. Additional examples of such applications include a VLAN manager, an overlay manager, a network address translation (“NAT”) manager, and so on. In some embodiments, on the northbound side, the SWM 250 exposes API-level access to the unified infrastructure and an internal RPC interface to connect to the XNS subsystem 240. For example, multiple classes or types of APIs can be provided in the SWM layer. Some APIs are an abstraction of switch functionality and are called switch abstraction interface (“SAI”) APIs. Some APIs are control plane and management APIs that allow discovery and provisioning of servers, VM life cycle management of launched virtual machines, monitoring APIs for retrieving CPU, disk, memory, and network statistics of the servers and/or VMs. On initialization, the SWM 250 initializes its local database store of distributed state (e.g., a collection of NAT mappings of private to public IP addresses, and/or server hardware information) and installs DHCP protocol intercept handlers on downstream ports. It establishes a secure SSL-based connection to the distributed control plane and registers the fabric controller to the front-end distributed control plane service called Switchboard. In some embodiments, during the initial connection, a one-time authorization token is exchanged and a challenge and response successfully negotiated through a shared secret between the SWM 250 and the distributed control plane Switchboard service.

In various embodiments, the technology provides virtualization within a physical SDFC controller that isolates, for example, the switching stack of the ToR switch from the control plane and from data plane applications running in the switch. Isolating network switching and routing features in SDFC helps to ensure network connectivity continues to function while other control and data plane applications are running concurrently. Because a failure in a network switching stack could effectively render the SDFC controller useless and require manual onsite intervention, the switching stack and control/data plane applications can be isolated through different methods.

In some embodiments, the SDFC controller provides isolation based on the capabilities of the underlying processing core. For example, if a CPU supports virtualization, the SDFC can use Hypervisor-based partition isolation with a switching stack running in one partition and applications such as inventory and firewall running in another partition or partitions. If the CPU does not support virtualization (e.g., a PowerPC® core used in a 1 GiB switch), the SDFC controller can use LXC (Container technology) to isolate the environment of the various application stacks. In some embodiments, the technology includes adaptive moving between Hypervisor and container-based process virtualization as defined by hardware capability. In addition, the SDFC can apply the same isolation techniques to isolate first-party and third-party applications within an app partition. For example, it can enable an Inventory Manager to run as a first party application while requiring a third-party monitoring software like a TAP device to be run in a separate partition or container. Proprietary virtualization software running on the physical controller can, within categories of applications (e.g., control or data plane applications) further isolate first party, second party and third party applications each with, or without, a separate automatic provisioning, patching, updating, and retiring model. In some embodiments, the technology provides virtualization of network switching ASIC functions that presents a virtualized ASIC to applications and acts as a final arbiter to access to the physical switching ASIC.

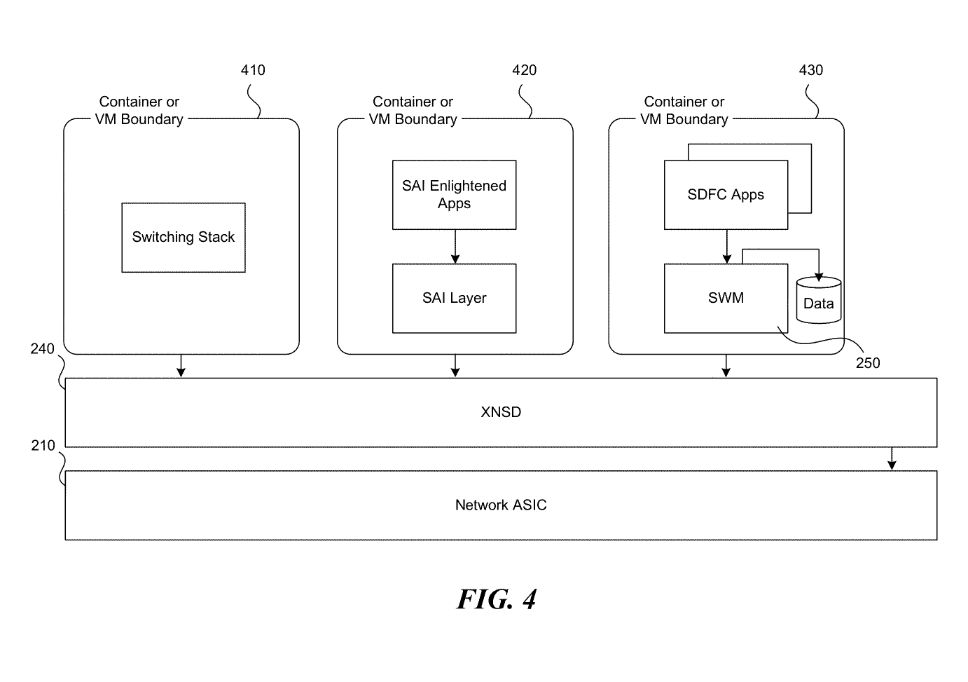

FIG. 4 is a block diagram illustrating separate software containers on an SDFC controller. In the depicted sample configuration, multiple applications are running on XNSD 240 in separate VM-based isolation partitions or containers 410-430. For example, a switching stack responsible for layer 2 switching (sending data to MAC addresses), source and destination MAC learning and support for VLAN runs in an independent partition 410. In some embodiments, when the platform supports hardware virtualization capabilities, the switching stack runs on a VM with hardware access to the ASIC 210 exposed through a virtual driver. An SAI layer in the second container 420 runs enlightened apps such as PXE boot server, DHCP and DNS server services built on top of the SAI framework. In the illustrated embodiment, the SAI layer allows API-driven creation of network routers, switches and programmatically allowing traffic to reach the enlightened apps. In a third VM 430, the SWM 250 shares the XNSD 240 and Network ASIC 210 platform and enables the execution of apps in the SWM 250 as described above. In some embodiments, the partitioning scheme is Hypervisor-based. In some embodiments, a process isolation boundary or container such as a Linux LXC can be used to provide a lesser degree of isolation. By isolating different stacks in different containers, the technology allows independent components to work reliably without correlated failures, e.g., allowing the switching software stack to remain operational even if one or more applications crash. The technology can accordingly support first-party and third-party applications running in partitions or containers in or on the SDFC controller (e.g., to inventory servers, virtualize a network, provision physical servers, perform placement of the VMs in the proximity zone, etc. The extensibility model built into the SDFC thus provides the ability to add private cloud services such as firewalls, traffic shaping for QoS, etc.

### Multi-Way Gossip Protocol (MwGP)

In various embodiments, the technology includes synchronization of configuration settings across ToR controllers, from a ToR controller to the cloud-based control plane, and from a ToR controller to an agent (e.g., a software agent) running on each server or virtual machine. The SDFC uses a protocol called the Multi-way Gossip Protocol or MwGP for state synchronization between different eFabric components including the cloud-based distributed control plane, the ToR controller, and the software agent running on servers and virtual machines. The “Multi-way Gossip Protocol” provides resiliency against transient network failures while allowing eFabric components to synchronize to a consistent state when network connectivity is restored. Each eFabric component maintains its own local copy of state, which can be updated independently of whether network connectivity is present or not. Each eFabric component also maintains a peer-to-peer connection with its immediate neighbors. If network connectivity is present an eFabric component immediately advertises state changes to its immediate neighbors. The neighbors then advertise state changes to their neighbors, and so on. In case of network failure, an eFabric component can continue to update its own local copy of state. When network connectivity is restored, the eFabric component advertises delta state updates to its neighbors, thereby allowing the neighbors to synchronize to the current state. Periodically, eFabric components also exchange full state information to protect against loss of delta state updates.

By distributing states across multiple instances of SDFC, eFabric provides resilience to a single point of failure to any entity in the system. The global state of the systems can be reconstructed from state fragments even if one of more individual instances are offline, for example, as in the presence of network partition. In various embodiments, state information is distributed on end servers for maximum scalability, while the SDFC controller preserves a cached replica of the state. For example, in contrast to other centralized controller systems, the SDFC can store state information (e.g., “truth state”) in leaf nodes (e.g., servers and virtual machines) and can use a bottoms-up mechanism to construct global state using state fragments from different leaf nodes. This approach allows the SDFC to be highly resilient against localized failures. Because there is no central repository where the entire state of the system is kept, the technology is much less vulnerable to a single event bringing down the system. This approach also allows the SDFC to scale horizontally without have to rely on the scalability of such a central database.

The Multi-way Gossip Protocol allows eFabric instances to exchange information about each other's state upon establishing a connection between a pair of SDFC instances. Each SDFC instance maintains a persistent local copy of its own state. The SDFC instance can update its own local state irrespective of whether network connectivity is present. When network connectivity is lost, the SDFC instance keeps track of local state updates. Once network connectivity is restored, the SDFC instance sends state updates to its neighbors which allows neighbor instances to converge to the current state. Periodically, SDFC instances exchange full state information in order to protect against lost state updates. A single eFabric instance only knows about its immediate neighbors and as neighbors communicate with each other, state is propagated throughout the system. Thus, MwGP can provide resiliency against network reachability failures as may happen due to, e.g., link down events or network partition events.

In some embodiments of the technology, an SDFC instance sends a Register message with a transmit (“Tx”) counter (e.g., a random integer value) to its neighbors either in a directory service (a well-known service endpoint) or its directly attached neighbors. In some embodiments, the SDFC instance provides a unique key as an authentication token. A neighbor can respond back with its own unique key and increment the Tx counter in the response message by one. The originating instance responds back, completing the registration handshake and incrementing the Tx counter by one in the final message. After the initial handshake is completed, a neighbor relationship is created, which is kept alive unless there is a neighbor timeout event, for example. Until such a timeout happens, messages with incremented Tx counters are used to exchange state fragments. When a timeout happens, the SDFC instance again sends a Register message (e.g., with a different Tx counter) and repeats the process described above.

In some embodiments, command and control operations such as creating virtual instances in the fabric are implemented on top of the underlying MwGP primitives. For example, when the SDFC API is called to create a new virtual machine in a certain proximity zone, the state fragment corresponding to the change in desired state can be percolated to the SDFC instances in the target proximity zone. If the eFabric in that target proximity zone does not allocate resources to effect that state change, then the state change fails from a global SDFC perspective. Failed commands can be retried by removing one or more policy constraints if the administrator so desires.

### Server Rack Provisioning and Communication

An SDFC instance, such as a ToR switch controller, can provision private clouds. For example, a ToR switch SDFC controller in a server rack can create, manage and monitor cloud-computing resources similar to a public cloud using the servers in the rack connected to the ToR switch. In some embodiments, the provisioning process of bare-metal servers is orchestrated by SDFC and the distributed control plane with minimal interaction required from the customer's perspective.

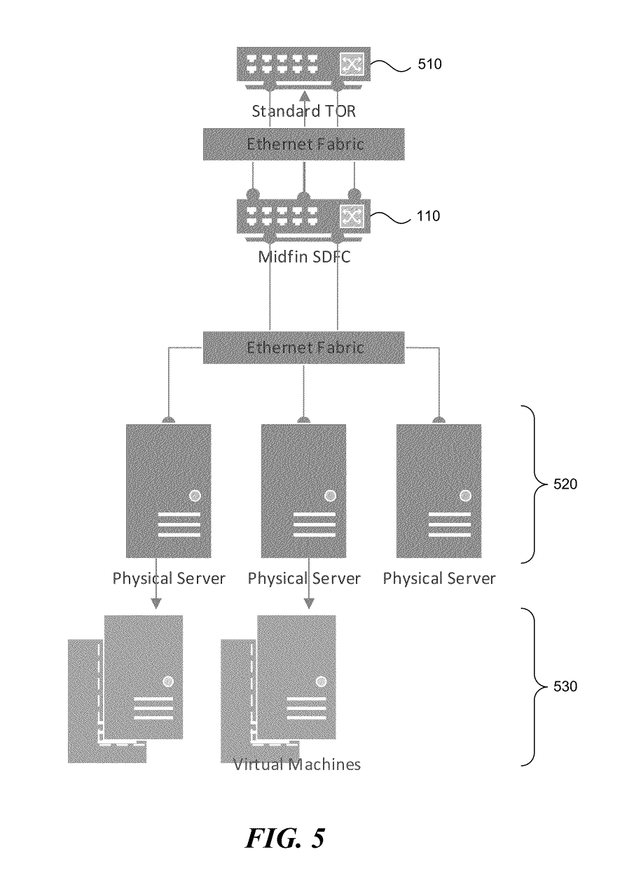

FIG. 5 is a schematic diagram illustrating an arrangement of components in a bump-in-the-wire mode accordance with an embodiment of the technology. In the illustrated topology, an SDFC instance 110 is connected in the BITW mode between the standard ToR switch 510 and physical servers 520 (and virtual servers 530) in the rack, enabling the SDFC instance 110 to intercept and retransmit data in transit (e.g., redirecting, encapsulating, or modifying such data). In this arrangement, the SDFC instance 110 can form and manage a software-defined networking fabric.

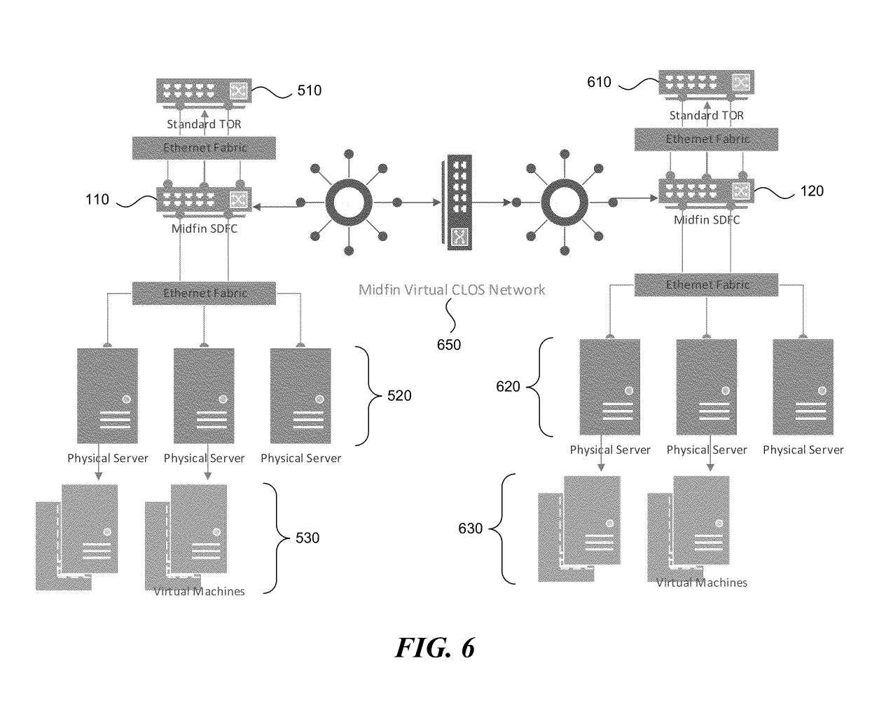

FIG. 6 is a block diagram illustrating an arrangement of components forming a virtual Clos network in accordance with an embodiment of the technology. In the illustrated arrangement, two SDFC instances 110 and 120 are connected in the BITW mode between their respective ToR switches 510 and 610 and physical servers 520 and 620 (and virtual servers 530 and 630). The SDFC instances 110 and 120 are connected via a virtual Clos network 650. The virtual Clos network 650 allows multiple SDFC instances to establish virtual tunnels between them for providing quality of service and reserved network bandwidth between multiple racks. In some embodiments, in the SDFC, the virtual Clos bridge 650 runs as a stand-alone application hosted either inside a container or virtual machine, as described above with reference to FIG. 4.

In some embodiments, the XNSD 240 of FIG. 2 creates a virtual Clos network 650 through the creation of proxy bridge interfaces connecting uplink ports (e.g., 23 ports) of one controller with uplink ports of another controller. Typically, a Clos network 650 requires physical topology changes and introduction of spine switches in a network to support east-west traffic. XNSD solves this through the proxy bridge interfaces created in software and allowing traffic to flow hash between virtual links across multiple SDFC instances over multiple racks. This provides an efficient model to virtualize and load-balance the links in the network.

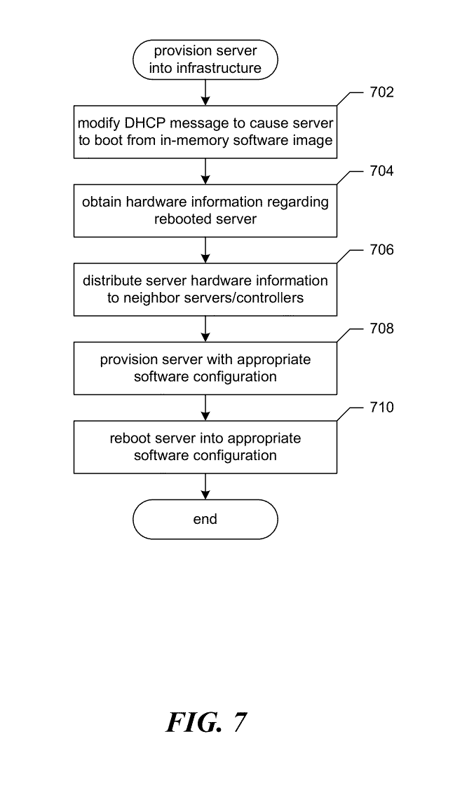

FIG. 7 is a flow diagram illustrating steps to provision a server in an SDFC in accordance with an embodiment of the technology. Discovery of servers typically involves installation of a software agent on the server, which queries server details and publishes such details to a central service. This process is cumbersome and requires changes to network configuration so that servers can be booted off the network using a protocol such as PXE. Additionally, the act of installing an agent makes irreversible changes to server state, thereby making the process non-transparent.

SDFC, on the other hand, supports transparent auto-discovery of servers without requiring changes to either the configuration of the network or the state of the server. In step 702, the SWM installs an intercept for DHCP packets using XNSD. When a DHCP request is received from a server that the SWM has not previously seen, the SWM records the MAC address and the IP address of the server and advertises it to the distributed control plane using MwGP. Where the SDFC controller is not running the DHCP service, the controller can use the intercept manager to intercept the DHCP response before it reaches the server. Subsequently, when the DHCP server replies with a DHCP offer, the SWM intercepts and modifies the DHCP offer packet by providing a boot file (DHCP option 67). The intercepted response packet is modified to specify a new boot source, e.g., the SDFC controller itself. The server receives the modified DHCP response packet and using the standard network PXE boot path to pick up the eFabric OS image from the SDFC. In some embodiments, the boot file provided by the SWM is a small in-memory image responsible for discovering the server. When the server receives the DHCP offer, it boots into the boot image supplied by the SWM. The boot code is memory resident (e.g., running from a RAM disk), and thus does not make any changes to the server's disk state. In step 704, the code queries various server properties such as the server's CPU, memory, disk and network topology, vendor information etc., and returns such information to the SWM. In step 706, the SWM then publishes this information to the distributed control plane, distributing the hardware state information to its reachable neighbors including the eFabric running on the controller itself. In some embodiments, a user interface enumerates the servers discovered and enables the user to request provisioning servers.

Typically, unattended server provisioning requires changes to the server's network configuration in order to boot the server off the network using a protocol like PXE. In contrast, the SDFC enables unattended server provisioning without requiring any changes to network configuration. In step 708, once a provisioning request is received, the SDFC instructs the memory-resident eFabric node running in the server to install a permanent copy on the server (e.g., on the HDD/SDD available locally). When the boot code is launched, the SWM supplies a uniform resource identifier (“URI”) of the OS image (e.g., a VM) that the user requested to be installed on the server to the boot code. The boot code writes the supplied OS image to disk. In step 710, the boot code then reboots the server. This time, SWM already knows about the server and does not supply a boot file. As a result, the server boots using the normal boot procedure. Upon reboot, the server boots using the user-supplied OS image provisioned in step 708, if any, and launches the installed operating system. The eFabric node then restarts and comes online ready for virtualization workloads from SDFC. When a virtual machine launch request is received in the SDFC through the distributed control plane, the SDFC can instruct the eFabric Agent to launch the virtual machine, bringing in all dependencies as needed. This process does not require any changes to network configuration or server state. The technology is able to inventory server hardware without making changes and to report it at scale across all SDFC and servers; automate provisioning through interception of boot protocol messages to create a seamless migration from bare-metal to fully-virtualized unified compute servers; and work with a customer's existing DHCP and BOOTP servers in the network, simplifying network configuration and partitioning. eFabric software can then monitor the VMs launched and provide updates to the distributed control plane on substrate resource usage (such as physical CPU, memory and disk) and virtual resource usage (such as virtual core commits, virtual NIC TX/RX, virtual Disk IOPS).

Those skilled in the art will appreciate that the steps shown in FIG. 7 may be altered in a variety of ways. For example, the order of the steps may be rearranged; some steps may be performed in parallel; shown steps may be omitted, or other steps may be included; etc.

In various embodiments, a physical controller in a rack that does not have switching software or act as a ToR switch can automatically perform bare metal provisioning of commodity servers in the rack, through the intercept manager and DHCP Boot options override described above. The SDFC can discover, inventory, and provision commodity bare metal servers attached to it (including servers of different makes and models). The SDFC is agnostic to the type of platform installed on the servers that are connected to it. For example, the SDFC can install an eFabric Node OS on the servers with an eFabric Agent as the primary candidate, or according to user preferences, a Microsoft Hyper-V solution, VMWare ESX-based virtualization platform, etc.

Today's datacenter bring-up models use a standard DHCP and PXE boot model to install their base platform from a centralized deployment servers. In the case of a Linux installation, for example, a TFTP server is used; or in the case of Windows, WDS (Windows Deployment Services) are used. Network administrators typically provision such environments in a VLAN to ensure isolation from production domains and to target only specific servers that they need to provision and bring online. In contrast, the SDFC-based approach can require no such network configuration or DHCP/TFTP/BOOTP/WDS Servers, because the SDFC subsumes all that functionality into a single controller and further provides finer grain control to pick the platform of choice at the integrated rack level. Thus, a Linux-based distribution can run one server room or rack and a Hyper-V platform can run another, both managed from an SDFC dashboard. The SDFC then continuously monitors the physical and virtual resources on the servers and reports state changes to its reachable neighbors, including the controller. In some embodiments, a software agent running on each server in the rack participates in the controller-based orchestration of private cloud resources (e.g., virtual machine lifecycle, distributed storage and network virtualization).

In various embodiments, a cloud-based control plane can orchestrate multiple controllers in different racks to stitch together a private cloud. In some embodiments, an SDFC instance communicates with the control plane through the switchboard service endpoint described above. After registration with the cloud-based control plane, the SDFC instance reports the servers it has detected and provides information on its topology to the control plane. The control plane can then request server provisioning steps to be carried out to bring the servers online as part of a unified infrastructure. Multiple SDFC controllers can perform the registration with the control plane and report all the physical servers connected to them using this model. The control plane can organize the servers through the proximity zones that they are associated with and maintain associations with the SDFC controller that reported the server for bare-metal provisioning.

In some embodiments, using the control plane services, users can register operating system images, create and manage blueprints that provide the virtual machine schema, and/or launch, start, stop, and/or delete virtual machines and containers in the UCI platform. The technology can include a web-based (and/or device- or computer application-based) dashboard that communicates with the cloud-based control plane to allow customer administrators and end-users self-service access to managing and monitoring the private cloud thus created. An on-premises SDFC controller can manage the infrastructure stitched through an optionally off-premises control plane. Such management also enables distribution of work (e.g., VM launch request, registration of images) through a policy-based placement engine that uses user and system-defined properties to drive placement and completion of work allocated. For example, given a request to launch a VM in Proximity Zone “Seattle-Colo-3-R4” with SSD Capability, the placement engine will translate this to a request that will be picked up by a unique SDFC instance managing the R4 in Colo-3 and then further allow VM launch only if SSD of requested capacity is available. In some embodiments, a placement decision is internally accomplished though a control plane tagging service that translates each requested property into a key-value tuple association requirement for satisfying the request. It can further allow control over “AND”/“OR”/“NOT” primitives among the key pairs to enable suitable matching of the SDFC instance to the control plane request. If an SDFC instance polls for work, the control plane will provide the first matching request that satisfies the policy set through such key-value tuples.

### Network Virtualization Using Offloaded Overlay Networks

In various embodiments, the technology uses overlay networks to layer a virtual network above a physical network, thereby decoupling virtual networks from physical networks. Overlay networks can employ encapsulation and decapsulation of VM packets in a physical network header, thereby ensuring packets are routed to the correct destination. Overlay networks are typically implemented in software in the virtual switch (“vSwitch”) of the hypervisor. This software implementation leads to poorer network performance as well higher CPU utilization in the server. For example, functions such as overlay construction, firewall, and NAT translation are done on the host system (server). this leads to costs in two dimensions: due to complexity and interaction with host OS network stack components, and due to performance overhead incurred on host-based processing.

In some embodiments of the technology, the SDFC offloads overlay network implementation to the SDFC controller, which can be either a virtual or a physical controller. In the case of a physical SDFC controller, encapsulation and decapsulation can be performed in hardware by the switching ASIC, thereby achieving line rate performance. By offloading encapsulation and decapsulation to the SDFC controller, the technology can achieve higher network performance as well as lower CPU utilization in the servers. In addition, since no software needs to run on the physical servers, the SDFC allows overlay networks to span both physical servers and virtual machines. For example, it allows a scenario where a bare-metal database server and a number of VMs running a web front end can be part of the same isolated virtual network. Another advantage of the offloading approach is that the SDFC can provide the same network virtualization capabilities across different Hypervisors and operating systems running on the server, because no network virtualization software is necessary on the server.

During startup, SDFC controllers discover other SDFC controllers using MwGP. Subsequently, a point-to-point overlay tunnel is created between each pair of SDFC controllers. Each such overlay tunnel specifies the IP address and port number of each endpoint. The overlay tunnel can use any of various overlay protocols including VXLAN and NVGRE. When a VM is launched under a SDFC controller, packet steering rules are installed to direct packets from this VM to other VMs in its virtual network. Specifically, packets whose destination MAC matches that of the target VM are tagged with the virtual network ID of the VM and sent to the target SDFC controller over the point-to-point overlay tunnel. When the destination SDFC receives the packet, it decapsulates the packet and sends it to the destination VM based on the destination MAC. Both encapsulation and decapsulation can be offloaded to the switching ASIC thereby achieving hardware accelerated performance.

In some embodiments, when a virtual machine is started up, the SDFC enables a VLAN translation engine between the SDFC port and the virtual machine NIC setup on the physical server. This System-defined VLAN translation enables the controller to create a direct-wire connection between the packets leaving the VM or entering the VM network and the fabric port. On the fabric controller side, a proxy NIC is created for the VM. In the case where there is a user-defined VLAN specified as part of the virtual machine launch, SDFC first performs the system-defined translation and then a user-defined translation of the VLAN so that the upstream (northbound) ports of the controller will emit the right user-defined VLAN to the ToR and the rest of the datacenter network. The network virtualization achieved through VLAN tag manipulation in the software also enables VMs to migrate seamlessly within a proximity zone from one physical server to another.

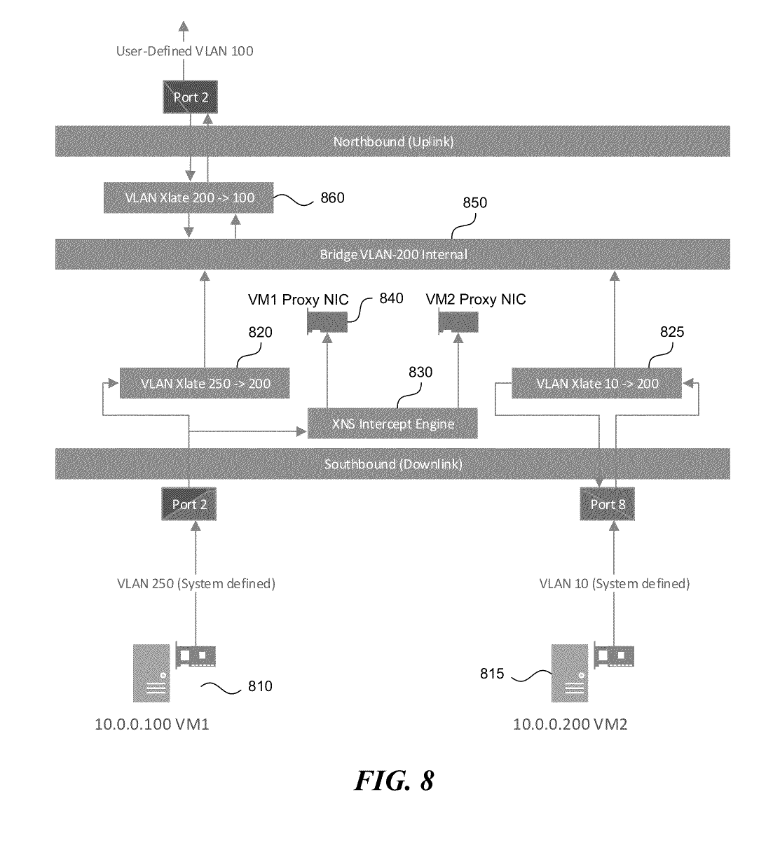

FIG. 8 is a data flow diagram illustrating SDFC VLAN Translation in Fabric mode in accordance with an embodiment of the technology. The illustrated data flow depicts traffic from a virtual machine 810 to the Internet. Each of the illustrated blocks 820-860 between the northbound (uplink) ports and the southbound (downlink) ports is within the SDFC or controller. Internally, an SDFC bridge 850 runs under an internal VLAN 200. A VM with a virtual machine NIC (VM1) 810 is placed on a server. No VLAN configuration is specified on the VM NIC, so it emits and receives normal untagged traffic. When the VM1 810 is launched, the SDFC creates a VLAN translation mapping entry 820 for the VM NIC. A VLAN is assigned by the SDFC as part of the VM NIC/VM launch (VLAN 250, in the illustrated example). The SDFC, through the XNS intercept engine 830, creates a proxy NIC 840 for the VM1 NIC in port 2, the fabric port through which the specific VM communication happens (because it is physically attached to that wire/port) and ties the VLAN 250 VM1 NIC 810 to the Proxy NIC 840 for communication going forward. The SDFC then allocates a system-defined mapping that it previously created for communication between VM1 810's NIC and the proxy NIC 840.

For example, VM1 810 starts up and sends a packet to reach an Internet host (e.g., google.com). Traffic leaving the virtual machine 810 is automatically tagged to VLAN 250 (when packets are sent from the VM NIC, the eFabric network virtualization agent wraps the packets in the VLAN 250 mapping) and sent to the proxy NIC 840. The Proxy NIC 840 unmaps the VLAN 250 traffic to VLAN 200 (or untagged) traffic and then forwards the traffic to the internal bridge 850. Because the traffic is leaving the proximity zone (Internet-bound), an SDFC translation engine 860 tags the traffic to VLAN 100 (user-defined) and forwards it to the northbound ports.

In the case of traffic from the virtual machine 810 to another virtual machine 820 within the same proximity zone, the above data flow differs. VM1 810 starts up and sends a packet to reach VM2 815. Traffic sent from VM1 810 is translated from VLAN 250 to internal bridge 200. The traffic is then translated from internal bridge 200 to VLAN 10, intended for VM2 815, by a VLAN translation mapping entry 825. The VM2 815 receives traffic switched through the SDFC in the correct system-defined VLAN 10.

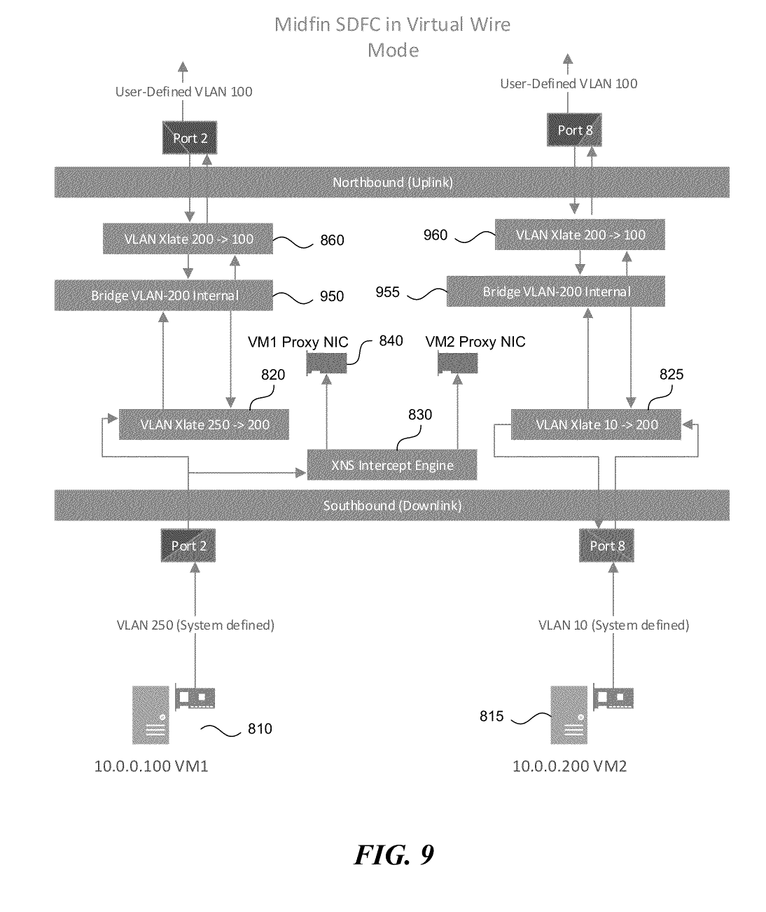

FIG. 9 is a data flow diagram illustrating SDFC VLAN Translation in Virtual Wire mode in accordance with an embodiment of the technology. In this mode, as opposed to the Fabric Mode illustrated in FIG. 8, the SDFC provides multiple internal bridges 950 and 955, for each port pair. For example, in the illustrated example, traffic from the VM1 810 to the VM2 815 egresses to the northbound port 2 and returns back to Port 8 northbound to reach the VM2 815. Both VMs are in VLAN 100 according to user configuration, but the translation performed in the path results in traffic leaving and re-entering the switch.

In some embodiments, XNSD provides network function virtualization capabilities that enable SDFC to create proxy virtual network interfaces (“VNIC”) for virtual machines running in the infrastructure. Through a proxy VNIC, VM network traffic is offloaded directly to the controller (rather than getting processed through the host's (e.g., Linux) networking stack, accumulating latencies) and creates a virtual wire between the VM and SDFC. For example, from the VNIC, traffic may hit the XTAP and be forwarded directly to the SDFC Proxy NIC, improving performance and reducing latency. By substantially reducing the packet path length, for example, the SDFC thus increases VM network performance and reduces jitter and latency in the network. In some embodiments, the controller enables an additional VLAN translation mode tagging untagged traffic arriving in different ports.

### Service Chaining

In some embodiments, the technology implements service chaining that enables a pipeline of network traffic processing by different network virtual functions arranged in a chain in a specified order, with arbitrary scaling on each link of the chain by spinning up more virtual machines. The SDFC supports the concept of service VMs to provide a dynamic packet pipeline for specific, filtered traffic patterns. Each stage of the packet pipeline can be handled by one or more service VMs and then forwarded to either an Internet-gateway or to another network endpoint (e.g., of the successive service VM), or just dropped, for example. Service chaining offers a mechanism to increase agility for SDFC users such as telecommunication entities. The ability to virtualize network functions and chain them in a user-defined manner allows such entities to reduce cost, increase agility and meet customer needs on demand.

The technology enables Network Function Virtualization (“NFV”) in the infrastructure and offloads the capabilities to the fabric controller as the orchestrator to manage the NFV-enabled infrastructure. One of the main advantages of NFV is the elasticity provided for capacity expansion of network elements that are virtualized and tethered together to meet the provisioning, configuration and performance needs of the virtualized infrastructure.

In some embodiments, the technology enables dynamic changes to an NFV pipeline and the ability to scale up or down the required network functions in the NFV pipeline through the SDFC orchestrator. As part of the NFV workflow, the technology can provide various NFV management APIs in the SDFC, such as: Register a VNF Service VM with registration type; One-to-One Service NIC (to allocate a new virtualized NIC for each VM using the VNF service); Many-to-One Service NIC (to allocate an existing tunneled VLAN virtualized NIC for any VMs using the virtualized network function (“VNF”) service, and enable virtual interfaces within the Service VM to disambiguate VNF clients); Launch a VNF Service VM in a specific unified compute infrastructure; Scale Up or Down a VNF Service VM in a specified unified compute infrastructure; Ground the VNF Service VM (resulting in a traffic black hole of the specific VNF service); Targeted Ground (to affect a specific instance); All running instances of the VNF Service VMs; Stop the VNF Service VM; and/or Terminate the VNF Service VM (disconnecting all clients attached to it prior to teardown of virtual NICs).

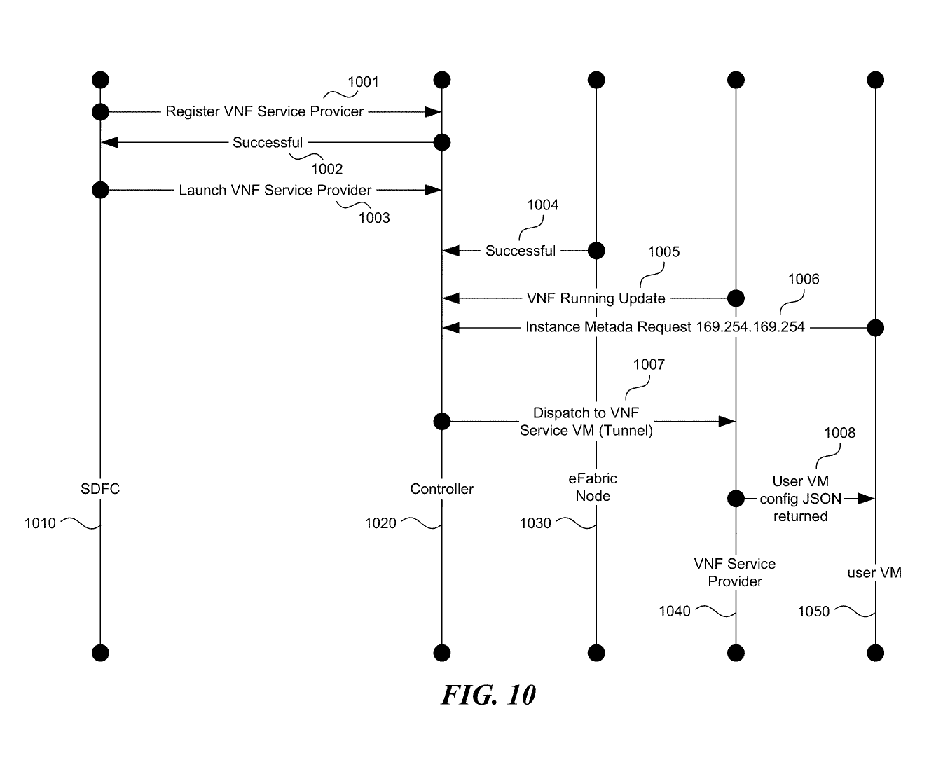

FIG. 10 is a sequence diagram illustrating virtualized network function interactions in accordance with an embodiment of the technology. In the illustrated example, a VM NIC 1050 queries its instance metadata endpoint to retrieve its configuration settings. In the illustrated embodiment, an Instance Metadata service runs as a service VM 1040 and hosts the configuration of all virtual machines or containers running with a fabric NIC. Various NFV elements in the SDFC 1010 work together to satisfy this request. In message 1001, the SDFC 1010 directs the SDFC controller 1020 to register a VNF service provider 1040. In message 1002, the controller 1020 reports success to the SDFC 1010. In message 1003, the SDFC 1010 directs the controller to launch the VNF service provider 1040. In message 1004, an eFabric node 1030 monitoring running services reports the successful launch of the VNF service provider 1040 to the controller 1020. In message 1005, the VNF service VM 1040 sends a status message to the controller 1020 that the VNF is running. In message 1006, a user VM 1050 sends a request to the controller 1020 for data about itself (using a special-purpose link-local IP address 169.254.169.254 for distributing metadata to cloud instances). In message 1007, the controller 1010 dispatches the request 1006 to the running VNF service VM 1040. In message 1008, the VNF service VM 1040 returns the requested user VM configuration metadata to the user VM 1050 (e.g., in JavaScript Object Notation (“JSON”) attribute-value pairs).

In some embodiments, to enable dynamic service chains, the SDFC is securely configured using a declarative mechanism such as a configuration file (e.g., text, JSON, binary, or XML). For example, the declarative mechanism can specify four parameters. First, a set of flow filters “f” that specify flows to be evaluated for NFV processing. Every packet that matches a filter in the set can be dispatched to the first stage of the chain. For example, suppose a web application is running on port 1234. Then the flow filter will contain destination port 1234, and as a result all packets destined to the service will be redirected to the first stage of the chain. Second, a number of stages “n” in the chain of processing engines applied to the flow. Third, one or more VM images “image,” that correspond to the Tth stage in the chain, uploaded to the distributed control plane. Fourth, the maximum number of instances “mᵢ” of image, that can be launched for the Tth stage of the chain. The actual number of instances will depend on load parameters like network traffic, CPU utilization, service latency etc. In some embodiments, the SDFC dynamically changes the number of instances based on user-defined policy.

SDFC uses the physical resources at its disposal to perform actions such as: creating mᵢ VM instances with image imageᵢ, starting from i=1 to i=n; provisioning interfaces on each VM, e.g., an interfaceᵢ₋₁ for receiving incoming packets or sending out flow termination packets (as in the case of an IPS VM), and an interaceᵢ₊₁ for forwarding packets to a VM in the next stage of NFV processing (wherein, for example, if i−1 is 1 then the egress packet goes to the client, and if i+1 is the target VM/service then it goes to the target); programming the ASIC to intercept and reroute packets matching f to the image₁ VMs; programming the ASIC to ensure that packets sent from image, VMs are automatically forwarded to the imageᵢ₊₁ VMs for i<n−1; programming the ASIC to ensure packets sent from imageₙ are sent to the target VM; and if mᵢ (the number of instances in the Tth stage) is greater than 1, programming the ASIC to flow-hash packets such that flows are distributed among mᵢ, instances

### CONCLUSION

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited except as by the appended claims.

We claim:

1. A method performed by a computing system having a processor for managing networked computer server resources, the method comprising:
receiving a dynamic host control protocol (“DHCP”) packet from a networked server;
when the computing system is not providing a DHCP service:
enabling the DHCP packet to reach a DHCP service provider; and
intercepting a DHCP response to the networked server, such that the intercepted DHCP response is not provided to the networked server;
creating a DHCP response that specifies a boot file;
transmitting the created DHCP response to the networked server, such that the networked server boots from the specified boot file;
receiving, from the networked server, information about the networked server;
identifying by the processor, based on the received information, a program executable by the networked server; and
prompting the networked server to obtain the identified program, such that the networked server can execute the identified program.

2. The method of claim 1, further comprising, after receiving the DHCP packet from a networked server:
obtaining from the DHCP packet an address of the server;
accessing a data structure containing records of addresses of servers configured by the computing system;
comparing the obtained address with the data structure records; and
determining, based on the comparing, that the computing system has not configured the server.

3. The method of claim 1 wherein the DHCP packet from the server is a Discover or Request packet, and wherein the DHCP response to the server is an Offer or ACK packet.

4. The method of claim 1 wherein the specified boot file source is a file provided by the computing system.

5. The method of claim 1, further comprising providing the specified boot file to the networked server.

6. The method of claim 5 wherein the provided boot file is configured to execute in memory on the networked server without modifying non-volatile data of the networked server.

7. The method of claim 1 wherein the received information about the networked server includes information about the server's CPU, memory, disk, network topology, or vendor.

8. The method of claim 1 wherein prompting the networked server to obtain the identified program includes transmitting a uniform resource identifier of an operating system or virtual machine image to be installed and executed on the networked server.

9. A computer-readable memory storing computer-executable instructions configured to cause a computing system to manage networked computer server resources by:
receiving a dynamic host control protocol (“DHCP”) packet from a networked server;
when the computing system is not providing a DHCP service:
enabling the DHCP packet to reach a DHCP service provider; and
intercepting a DHCP response to the networked server, such that the intercepted DHCP response is not provided to the networked server;
creating a DHCP response that specifies a boot file;
transmitting the created DHCP response to the networked server, such that the networked server boots from the specified boot file;
receiving, from the networked server, information about the networked server;
identifying by the processor, based on the received information, a program executable by the networked server; and
prompting the networked server to obtain the identified program, such that the networked server can execute the identified program.

10. The computer-readable memory of claim 9 wherein the DHCP packet from the server is a Discover or Request packet, and wherein the DHCP response to the server is an Offer or ACK packet.

11. The computer-readable memory of claim 9 wherein the specified boot file source is a file provided by the computing system.

12. The computer-readable memory of claim 9, further comprising providing the specified boot file to the networked server.

13. The computer-readable memory of claim 12 wherein the provided boot file is configured to execute in memory on the networked server without modifying non-volatile data of the networked server.

14. The computer-readable memory of claim 9 wherein providing the identified program to the networked server includes transmitting a uniform resource identifier of an operating system or virtual machine image to be installed and executed on the networked server.

15. A system for managing networked computer server resources, the system comprising:
a packet interception component configured to receive a dynamic host control protocol (“DHCP”) packet from a networked server,
wherein, when the system is not providing a DHCP service, the packet interception component is configured to enable the DHCP packet to reach a DHCP service provider, and to intercept a DHCP response to the networked server, such that the intercepted DHCP response is not provided to the networked server;
a DHCP response component configured to create a DHCP response that specifies a boot file, and to transmit the created DHCP response to the networked server, such that the networked server boots from the specified boot file;
a server identification component configured to receive, from the networked server, information about the networked server, and to identify, based on the received information, a program executable by the networked server; and
a provisioning component configured to prompt the networked server to obtain the identified program, such that the networked server can execute the identified program.

16. The system of claim 15 wherein the packet interception component is configured to:
receive substantially all network traffic;
examine the contents of the network traffic; and
select traffic whose contents include a DHCP packet.

17. The system of claim 15 wherein the DHCP packet from the server is a Discover or Request packet, and wherein the created DHCP response to the server is an Offer or ACK packet.

18. The system of claim 15 wherein the DHCP response component specifies a file provided by the system as the boot file source; and further comprising a file access component configured to enable the networked server to obtain the specified boot file.

19. The system of claim 18 wherein the provided boot file is configured to execute in memory on the networked server without modifying non-volatile data of the networked server.

20. The system of claim 15 wherein the provisioning component is configured to transmit a uniform resource identifier of an operating system or virtual machine image to the networked server.
